(19) United States
(12) Patent Application Publication
(10) Pub. No.: US 2015/0028569 A1
(43) Pub. Date: Jan. 29, 2015

(54) Protective Covering Apparatus and Method for Vehicle Handlebars

(71) Applicant: Michael D. Sharp, Kinderhook, NY (US)

(72) Inventor: Michael D. Sharp, Kinderhook, NY (US)

(21) Appl. No.: 14/513,268

(22) Filed: Oct. 14, 2014

Related U.S. Application Data
(60) Provisional application No. 61/891,953, filed on Oct. 17, 2013.

(51) Int. Cl. B60J 11/06; B62J 19/00; B62J 33/00; B62J 17/00

(52) U.S. Cl. CPC B60J 11/06; B62J 17/00; B62J 19/00; B62J 33/00
USPC 280/727; 150/167

(57) ABSTRACT

Protective covering bags for handlebars for vehicles such as motorcycle as the like, which allows the vehicle to be operated while the bags are in place over the handlebars. Specifically, a covering apparatus for protecting the handlebars and handlebar controls of a handlebar-controlled vehicle, comprising: a left-handed covering comprising a left handlebar opening thereof, sized to fit over and enclose a left handlebar of the vehicle and any controls on the left handlebar; and a right-handed covering comprising a right-handlebar opening thereof, sized to fit over and enclose a right handlebar of the vehicle and any controls on the right handlebar; wherein: the left and right handlebar coverings are similar but are not identical, possessing opposite handedness from one another; and the left and right handlebar coverings comprise a weatherproof or weather-resistant material.

### CROSS REFERENCE TO RELATED APPLICATIONS

This application claims priority of pending provisional application 61/891,953 filed Oct. 17, 2013, which is hereby incorporated by reference in its entirety.

### BACKGROUND OF THE INVENTION

In a motor vehicle or velocipede for which the user control and steers the vehicle using handlebars, and especially as regards motorcycles in particular, the handlebars and associated controls are expensive and delicate devices which can corrode and malfunction if they are not suitably protected from weather and road debris and related environmental elements.

It is therefore very desirable to provide weather protection for the handlebars and handlebar-situated controls of a motor vehicle especially but not limited to motorcycles. This protection is desirable when the vehicle is not in use, but it is also desirable when the vehicle is in use. For example, a motorcycle may be driven during rain or snow or sleet, and also subjected to road debris. Or, it may be stored in the elements. Or it may be transported through the elements while it is not being used, e.g., on the back deck of an open truck. In all these cases, it is desirable to shield the handlebars and controls from these elements whether the vehicle is in use or not.

It is also desirable to be able to shield the operator's hands from these same elements and road debris, and also to keep the operator's hands warm and dry, when the vehicle is in fact being operated.

It is also desirable to increase the area of commercial space available on motorcycles or similar vehicles.

While the apparatus and method disclosed here to meet these and other objectives is intended for motorcycles, other vehicles suitable for use of this invention include all velocipedes, mopeds, dirt bikes, and any other motorized or user-powered vehicle which contain two handlebars.

### SUMMARY OF THE INVENTION

Protective covering bags for handlebars for vehicles such as motorcycle as the like, which allows handlebars and associated controls to be protected while a handle-operated vehicle is not in use, and which also allows the vehicle to be operated and the operator's hands to be kept warm and dry while the protective bags are in place over the handlebars.

Specifically disclosed is a covering apparatus for protecting the handlebars and handlebar controls of a handlebar-controlled vehicle, comprising: a left-handed covering comprising a left handlebar opening thereof, sized to fit over and enclose a left handlebar of the vehicle and any controls on the left handlebar; and a right-handed covering comprising a right-handlebar opening thereof, sized to fit over and enclose a right handlebar of the vehicle and any controls on the right handlebar; wherein: the left and right handlebar coverings are similar but are not identical, possessing opposite handedness from one another; and the left and right handlebar coverings comprise a weatherproof or weather-resistant material.

### BRIEF DESCRIPTION OF THE DRAWINGS

The features of the invention believed to be novel are set forth in the appended claims. The invention, however, together with further objects and advantages thereof, may best be understood by reference to the following description taken in conjunction with the accompanying drawing(s) summarized below.

FIG. 1 is a schematic plan view illustrating a representative pair of handlebars and related controls such as are commonly employed in the art for motorcycles and related motorized or user-powered vehicles. This schematic is drawn to be view-neutral; that is, it does not distinguish between whether the handlebars are being viewed from the front of the vehicle or from its rear. Typically, these handlebars and related controls are unprotected when the vehicle is not in use but outdoors, and also, when it is in use.

FIG. 2 illustrates a front plan view of a preferred embodiment for a pair of left- and right-handed protective handlebar coverings, e.g., protective bags, before they have been placed into use over a pair of handlebars or after they have been removed.

FIG. 3 illustrates a rear plan view of the pair of protective handlebar coverings of FIG. 2.

FIG. 4 illustrates a front plan view of the protective handlebar coverings of FIG. 2 when placed over the representative handlebars of FIG. 1.

FIG. 5 illustrates a rear plan view of these protective handlebar coverings when placed over the handlebars.

FIG. 6 is the same illustration is FIG. 5, after a drawstring and lock system of the coverings has been actuated and after a pair of hand opening cover flaps of the coverings have been opened.

### DETAILED DESCRIPTION

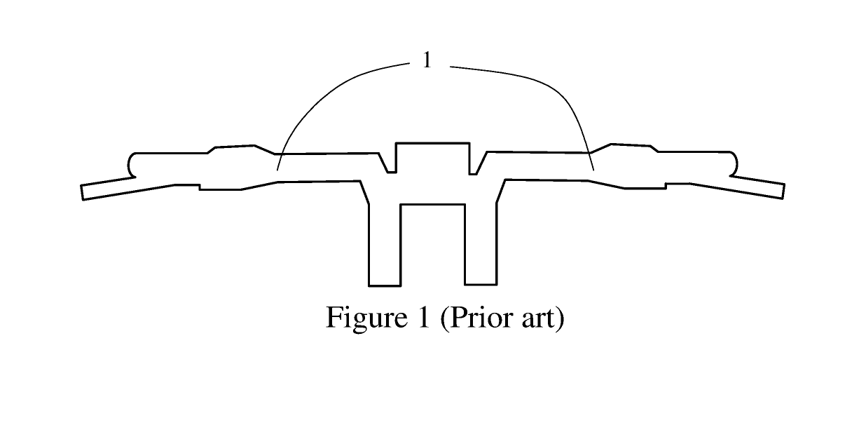

FIG. 1 illustrates a pair of unprotected vehicle handlebars and controls 1. The object of this invention to now be disclosed, is to protect these handlebars and controls 1 from the elements when the vehicle is not in use, and also, optionally, when the vehicle is in use. An implicit simultaneous benefit of protecting the handlebars when the vehicle is in use is that the hands of the user/operator may also be shielded from the elements and kept warm while controlling the vehicle. While this disclosure will for brevity often refer to protecting the handlebars 1 from the elements, it is to be understood that any such reference to the handlebars 1 is intended to cover both the handlebars themselves, and the controls which are part of and/or attached to the handlebars.

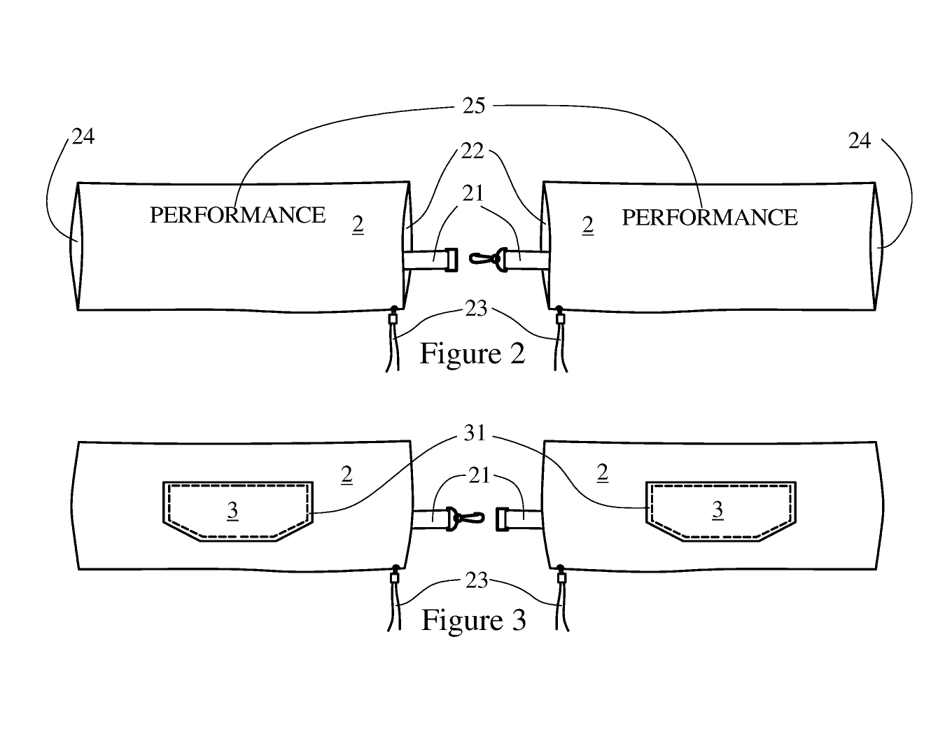

FIGS. 2 and 3 illustrate front and rear views, respectively, of a pair of handlebar coverings 2, e.g., bags, before they have been placed into use over the pair of handlebars 1 or after they have been removed therefrom. These coverings 2 preferably comprise a durable, weather-resistant, flexible fabric such as but not limited to tightly-woven nylon or leather. They may optionally comprise one or more inside hand-warming layers with wool, fleece, cotton, down or a similar warm material to help warm the hands of the operator for cold weather use. Each covering 2 comprises a complementary covering attachment component 21 such as, but not limited to the illustrated strap and clip/hook system. That is, the left covering 2 comprises a left-covering attachment 21 and the right covering 2 comprises a right-covering attachment 21 with these left- and right-covering attachments 21 complementary to and mating with one another so as to mutually attach the left-covering 2 and the right-covering 2 to one another at will. When the coverings 2 are not being used, the attachment system comprising the two complementary attachment components 21 may be used to connect the two coverings 2 together for storage and transport, so that they do not become separated with the potential for one of the coverings to become lost without the other. In the illustration of FIGS. 2 and 3, however, the attachment components 21 are illustrated as being detached from one another.

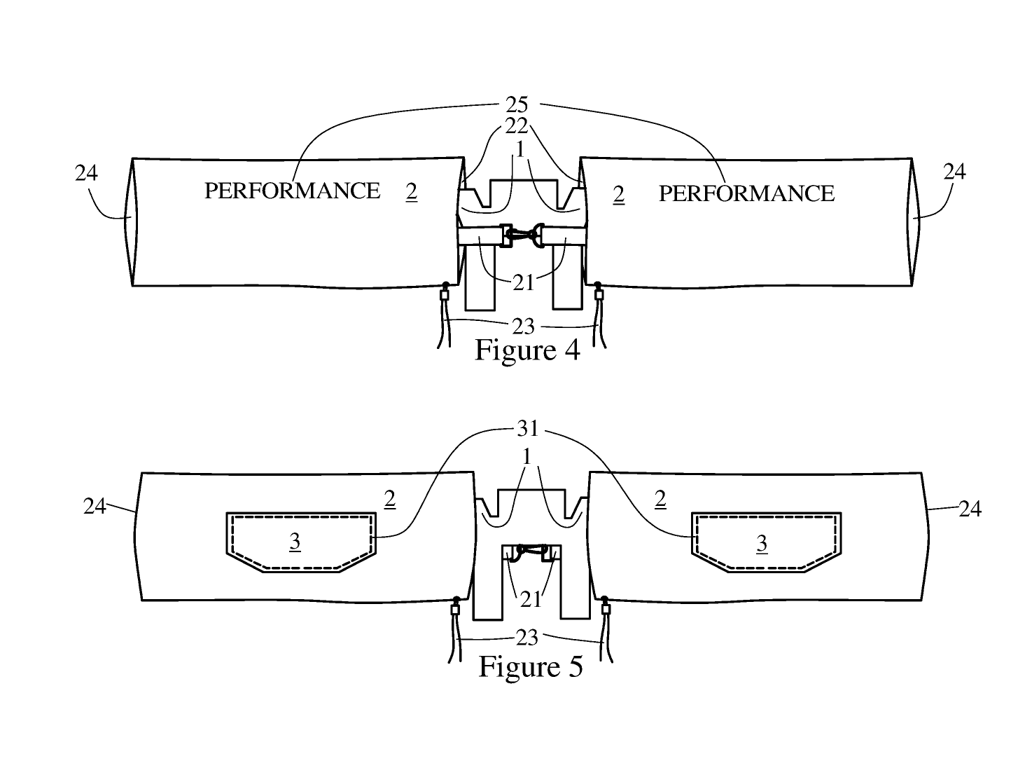

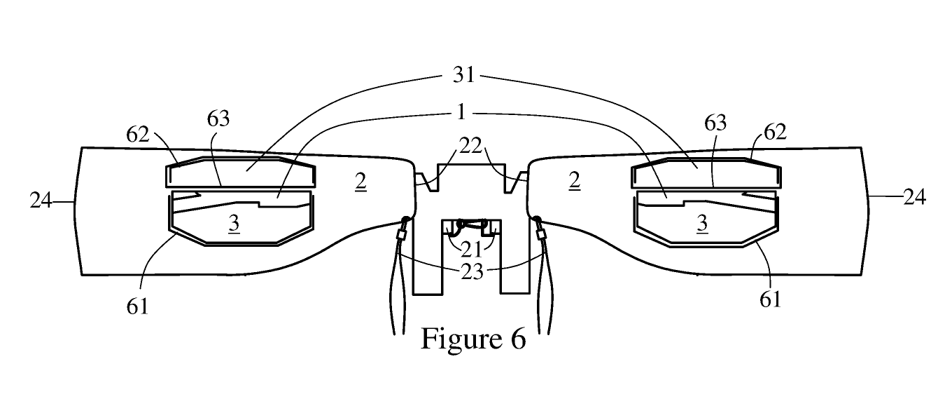

Each covering 2 further comprises a handlebar opening 22 used to slide the covering 2 over the handlebars 1 for protection, as will be momentarily discussed in connection with FIGS. 4 and 5. Additionally, it is optional but preferred for each covering 2 to comprise a durable drawstring and lock system 23 or equivalent, such as is well-known in the art, running about the circumference of the handlebar openings 22. As will be further seen in FIG. 6, this is so that once the coverings 2 have been slid over the handlebars 1, the drawstrings can be pulled and then locked in place to reduce the circumference of the handlebar openings 22 and thus give the openings a tightened fit about the handlebars 1. To remove the coverings 2 from the handlebars 1, the drawstring and lock system 23 is unlocked and loosened in the customary manner, and then the coverings 2 may be removed from the handlebars 1.

These two coverings 2 are similar but are not identical, insofar as they possess opposite handedness from one another. Thus, a left-handed covering 2 comprising a left handlebar opening 22 thereof, is sized to fit over and enclose a left handlebar 1 of the vehicle and any controls on the left handlebar 1. Similarly, a right-handed covering 2 comprising a right-handlebar opening 22 thereof, is sized to fit over and enclose a right handlebar 1 of the vehicle and any controls on the right handlebar 1, with opposite handedness a.k.a. parity.

At the opposite end from the handlebar openings 22, which end is closed, the coverings 2 optionally comprise a durable semi-hard material 24 such as rubber or an equivalent material of like flexibility and durability, so that the handlebars 1 will be protected if their ends are leaned against a wall or pavement or some similar hard or rough surface.

Because the coverings 2 are to be placed over the handlebars 1 of motorcycles or other related handle-operated vehicles, and because it is often thought desirable by advertisers or users to place commercial trade names and logos on such vehicles, e.g., Motocross, the coverings 2 may optionally contain one or more commercial marks 25 printed thereon, as is also illustrated in FIG. 3. This is an additional benefit of the invention, because it provides additional commercial space upon motorcycles which often already have much of their free space used for commercial names, logos and similar commercial devices.

When viewed from the rear as in FIG. 3, each covering 2 also contains an operator hand opening 3 bounded by the hidden lines in FIG. 3, as well as a hand opening cover flap 31 thereover. When closed, the flap 31 covers the hand opening 3, and about its perimeter contains suitable stitching and/or a Velcro®-type system and/or a zipper (later illustrated in FIG. 6), to enable most or all of the flap 31 to be detached from the hand opening 3 at will. This is so that the operator's hand can be placed through the hand openings 3 to contact the handlebars 1 and their controls and thus operate the vehicle even when the coverings 2 are still in place over the handlebars 1.

It will be appreciated from all of the foregoing that while each of these two coverings 2 are very similar, they are not identical. Rather, they are oppositely-handed (opposite-parity) versions of one another, and that a left-handed one of these coverings 2 will be used to protect the left handlebar 1 and its controls and that a right-handed one of these coverings 2 will be used to protect the left handlebar 1.

To use these handlebar coverings 2 to protect the vehicle handlebars 1, the user first separates the two handlebar coverings 2 by decoupling the complementary attachment components 21. So in the drawings here in which a strap and clip/hook system is used without limitation to exemplify the complementary attachment components 21, the user detaches the two portions of the illustrated clip/hook system from one another, as shown in FIGS. 2 and 3. The user then separates the handlebar coverings 2 from one another, and for each one then slides the handlebar openings 22 over the handlebars 1 from opposite sides. Then, the complementary attachment components 21 are coupled together, e.g., the hook is placed about the clip and then closed. So for the exemplary strap and clip/hook system used in the illustrations, this means that the two portions of the illustrated clip system are now hooked together. The result of all this is the illustration of FIGS. 4 (front view) and 5 (rear view).

It will be appreciated that in this configuration of FIGS. 4 and 5 wherein the handlebar coverings 2 have been placed over the vehicle handlebars 1 and the complementary attachment components 21 have been coupled together, these handlebar coverings 2 will maintain their position covering the handlebars by virtue of this coupling of the complementary attachment components 21. It will also be appreciated that any commercial marks 25 printed on the front of the handlebar coverings 2 will be visible from the front of the vehicle, such that the handlebar coverings 2 simultaneously make additional commercial space available on the vehicle. The illustration of commercial marks 25 on the front of the handlebar coverings 2 is exemplary not limiting. Indeed, commercial marks 25 or any other sorts of emblems may be placed anywhere and everywhere on the handlebar coverings 2, if desired.

It will also be appreciated that if one of the ends of the handlebars 1 should be leaned against any hard or rough surface, that the optional durable material 24 such as rubber or an equivalent will provide protection for the handlebar ends. Finally, it will be appreciated that the durable weatherproof or weather-resistant handlebar coverings 2 will indeed protect the handlebars 1 from rain, snow, sleet, road debris and similar elements whenever they are situated over the handlebars 1.

FIG. 6 is similar to FIG. 5, but now the user proceeds to take two additional steps. First, the user draws and locks the drawstring and lock systems 23 or equivalent into a tightened position, so that the circumferences of the handlebar openings 22 are reduced and the handlebar openings 22 thereby form a tight fit about the handlebars 1, as illustrated. This maintains the coverage of the handlebar coverings 2 over the handlebars 1 independently of the coupling via the complementary attachment components 21.

Second, when the user is ready to operate the vehicle, but wishes to keep the handlebar coverings 2 in place so as to protect the handlebars, the user opens the hand opening cover flaps 31 to directly expose the hand openings 3. With the hand openings 3 so-exposed, it will be seen that a portion of the handlebars 1 becomes visible through the hand openings 3, and more importantly, that the operator can then slide his or her hands through the hand openings 3 to be able to grip the handlebars and its controls 1 and thereby operate the vehicle while the protection afforded by the handlebar coverings 2 is still maintained. Thus, the hand openings 3 are sufficiently-sized to fit an operator's hands therethrough. In this manner, the handlebar coverings 2 not only protect the handlebars 1, but they simultaneously act a loose glove or as a “hand-jacket” for the operator's hands. This is why it is desirable to optionally provide one or more inside layers for handlebar coverings 2 with wool, fleece, cotton, down or a similar warming material for cold weather use. Indeed, all of the considerations which would normally apply to designing coats and jackets for motorcycle operators would apply equally to the design of any inside layers of the handlebar coverings 2, including the use of “zip-out” linings so that the handlebar coverings 2 can be converted among warm, intermediate and cold weather use configurations.

In FIG. 6, the hand opening cover flaps 31 are illustrated to be situated above the hand openings 3 while still attached to the handlebar coverings 2. While a person of ordinary skill may find a number of ways to achieve this sort of functionality all within the scope of this disclosure and its associated claims, it is understood that in the exemplary, non-limiting illustration of FIG. 6, the flaps 31 maintain a permanent attachment (for example, via a permanent weave) to the handlebar coverings 2 along a permanent flap attachment region 63 over one aspect of their perimeter. At the same time, the flaps 31 are detachable and re-attachable along the other three aspects of their perimeter, via complementary flap attachment and detachment devices 61 and 62 such as, in one embodiment, a zipper, and in another embodiment, a hook-and-loop system such as Velcro®.

So, for example, in a Velcro® et al. embodiment, there is one strip of Velcro® along 61, and there is a complementary strip of Velcro® mating therewith along 62. So to open the flaps 31 the user simply separates the Velcro® and the lifts the flaps 31 out of the way of the hand openings 3, and to close the flaps 31 the user simply presses the complementary Velcro® strips back together. The same sort of procedure is followed via unzipping and rezipping for a zipper embodiment. While it is highly preferred that there be permanent flap attachments such as at regions 63 so that the flaps 31 do not become separated from the rest of the handlebar coverings 2 and thus placed at risk of being lost, the handlebar coverings 2 may optionally be designed to allow complete detachment and reattachment of the flaps 31 along their entire perimeter. In this instance, the user would of course need to securely store the flaps 31 somewhere else, whenever they have been removed. So in sum, these flaps 31 in all embodiments are at least partially-detachable, and in an optional albeit less-preferred embodiment, they are fully detachable from the coverings 2.

One may also employ a weather-resistant zipper in combination with the Velcro® over part or the entire perimeter of the flap 31 to keep out debris from entangling with the Velcro®. In this way, both the Velcro® and the zipper embodiments are used together, with the zipper protecting the Velcro®. To access the controls while the coverings 2 are situated over the handlebars 1, the user first opens the zipper and then separates the Velcro®.

When the user does not wish to use the handlebar coverings 2 any longer, the user simply applies the reverse method from what has been disclosed thus far. The flaps 31 over their entire perimeter are reattached to the handlebar coverings 2, the drawstring and lock systems 23 or equivalent are withdrawn to loosen the handlebar openings 22, the complementary covering attachment components 21 are decoupled, and the handlebar coverings 2 are removed from over the handlebars 1, all to arrive back at the configuration of FIGS. 2 and 3. Finally, starting from FIGS. 2 and 3, the complementary covering attachment components 21 are coupled (e.g., hooked) together, so that the handlebar coverings 2 become paired together and there will not be a risk of one covering 2 becoming lost in relation to the second covering 2 when these are not in use.

As already noted, the coverings 2 should preferably be waterproof, and maintain a tight weatherproof seal. This prevents electrical contacts on the handlebars 1 from wetting and corrosion and maintains the handlebars 1 in good, new condition.

The coverings 2 are sized so to cover the handlebars and controls 1 substantially completely. As a beneficial by-product, this simultaneously creates visual space that is of sufficient dimension to allow at will placement of logos, trademarks, and other visual advertising and promotional devices 25. In an art area such as motocross, such advertising and promotional space is highly desirable and branding is a very premier value and necessity. Simply covering the ends of the handlebars and not the entire handlebar and controls 1 would neither provide proper weather protection nor provide sufficient visual promotional space.

This invention also cures the prior art practice of users placing large trash bags over their handlebars and controls 1 for protection. This is not only unsightly, but when these trash bags are disposed, this adds non-biodegradable substances to landfill space. So in this manner, this invention reduces the use of non-biodegradable substances and promoted environmental values.

Any suggestion of sizes and dimensions is illustrative, not limiting. The appearance of the logo/commercial mark 25 PERFORMANCE in the drawings is illustrative, not limiting, and shows how the invention can provide space for advertising using various logos, trade names, etc.

This invention provides a method for sealing the handlebars and controls 1 on a bicycle, motorcycle, ATV, or any other vehicle with handlebars 1. One takes the open end 22 of the coverings 2, slips the coverings 2 over the controls and the handlebars 1, and then mates the complementary covering attachment components 21 and pulls the drawstrings or equivalent components 23 to secure the open ends 22 in a substantially-closed position over the handlebars and controls 1.

Again, the complementary covering attachment components 21 such as but not limited to the illustrated strap and clip system are used to secure the two coverings 2 to one another so they will not separate from the handlebars 1, and so that the coverings 2 stay together when they are not in use.

Finally, by also thinking of the two coverings 2 as simultaneously being outerwear apparel for the operator's hands, the provision of suitable layering for warmth and weatherproofing effectively allows the operator's hands to be protected. Thus, the operator may forego the use of regular gloves, have his or her hands directly in contact with the handlebars and controls 1 while operating the vehicle, and still maintain his or her hands in comfort and warmth. This enhances control for the operator and thus contributes to a safer vehicle ride.

The knowledge possessed by someone of ordinary skill in the art at the time of this disclosure, including but not limited to the prior art disclosed with this application, is understood to be part and parcel of this disclosure and is implicitly incorporated by reference herein, even if in the interest of economy express statements about the specific knowledge understood to be possessed by someone of ordinary skill are omitted from this disclosure. While reference may be made in this disclosure to the invention comprising a combination of a plurality of elements, it is also understood that this invention is regarded to comprise combinations which omit or exclude one or more of such elements, even if this omission or exclusion of an element or elements is not expressly stated herein, unless it is expressly stated herein that an element is essential to applicant's combination and cannot be omitted. It is further understood that the related prior art may include elements from which this invention may be distinguished by negative claim limitations, even without any express statement of such negative limitations herein. It is to be understood, between the positive statements of applicant's invention expressly stated herein, and the prior art and knowledge of the prior art by those of ordinary skill which is incorporated herein even if not expressly reproduced here for reasons of economy, that any and all such negative claim limitations supported by the prior art are also considered to be within the scope of this disclosure and its associated claims, even absent any express statement herein about any particular negative claim limitations.

Finally, while only certain preferred features of the invention have been illustrated and described, many modifications, changes and substitutions will occur to those skilled in the art. It is, therefore, to be understood that the appended claims are intended to cover all such modifications and changes as fall within the true spirit of the invention.

I claim:

1. A covering apparatus for protecting the handlebars and handlebar controls of a handlebar-controlled vehicle, comprising:
a left-handed covering comprising a left handlebar opening thereof, sized to fit over and enclose a left handlebar of the vehicle and any controls on the left handlebar; and
a right-handed covering comprising a right-handlebar opening thereof, sized to fit over and enclose a right handlebar of the vehicle and any controls on the right handlebar; wherein:
said left and right handlebar coverings are similar but are not identical, possessing opposite handedness from one another; and
said left and right handlebar coverings comprise a weatherproof or weather-resistant material.

2. The apparatus of claim 1:
a rear surface of said left-handed covering comprising a left operator hand opening and a left hand opening cover flap situated thereover, wherein said left hand opening cover flap is at least partially-detachable from said rear surface of said left-handed covering; and
a rear surface of said right-handed covering comprising a right operator hand opening and a right hand opening cover flap situated thereover, wherein said right hand opening cover flap is at least partially-detachable from said rear surface of said right-handed covering; wherein:
said left and right hand openings are sufficiently-sized to fit an operator's left and right hands therethrough, respectively.

3. The apparatus of claim 2, said left and right handlebar covers further comprising at least one inside hand-warming layer for warming the operator's hands when those hands are placed through said operator hand openings.

4. The apparatus of claim 2, wherein said at least partial detachability of said flaps from said coverings is enabled by a hook-and-loop system such as Velcro®.

5. The apparatus of claim 2, wherein said at least partial detachability of said flaps from said coverings is enabled by a zipper.

6. The apparatus of claim 4, wherein said hook-and-loop system is protected from debris by a zipper.

7. The apparatus of claim 1, said left covering comprising a left-covering attachment and said right covering comprising a right-covering attachment with said left-covering attachment and said right-covering attachment complementary to and mating with one another so as to mutually attach said left covering and said right covering to one another.

8. The apparatus of claim 1:
said left covering comprising a left drawstring and lock system or equivalent running about a circumference of said left handlebar opening for tightening said left covering about the left handlebar; and
said right covering comprising a right drawstring and lock system or equivalent running about a circumference of said right handlebar opening for tightening said right covering about the right handlebar.

9. The apparatus of claim 1, at least one of said coverings comprising at least one commercial mark thereon.

10. The apparatus of claim 1:
a rear surface of said left-handed covering comprising a left operator hand opening and a left hand opening cover flap situated thereover, wherein said left hand opening cover flap is at least partially-detachable from said left-handed covering;
a rear surface of said right-handed covering comprising a right operator hand opening and a right hand opening cover flap situated thereover, wherein said right hand opening cover flap is at least partially-detachable from said right-handed covering;
said left and right handlebar covers further comprising at least one inside hand-warming layer for warming the operator's hands when those hands are placed through said operator hand openings;
said left covering comprising a left-covering attachment and said right covering comprising a right-covering attachment with said left-covering attachment and said right-covering attachment complementary to and mating with one another so as to mutually attach said left covering and said right covering to one another;
said left covering further comprising a left drawstring and lock system or equivalent running about a circumference of said left handlebar opening for tightening said left covering about the left handlebar; and
said right covering further comprising a right drawstring and lock system or equivalent running about a circumference of said right handlebar opening for tightening said right covering about the right handlebar; wherein:
said left and right hand openings are sufficiently-sized to fit an operator's left and right hands therethrough, respectively.

11. A method for protecting the handlebars and handlebar controls of a handlebar-controlled vehicle, comprising:
fabricating left and right handlebar coverings comprising a weatherproof or weather-resistant material; wherein said left and right handlebar coverings are similar but are not identical, possessing opposite handedness from one another;
placing over a left handlebar of the vehicle and any controls on the left handlebar, said left-handed covering comprising a left handlebar opening thereof, sized to fit over and enclose the left handlebar and any controls on the left handlebar; and
placing over a right handlebar of the vehicle and any controls on the left handlebar, said right-handed covering comprising a right handlebar opening thereof, sized to fit over and enclose the right handlebar and any controls on the right handlebar.

12. The method of claim 11, further comprising:
at least partially-detaching from a rear surface of said left-handed covering, a left hand opening cover flap situated over a left operator hand opening on said rear surface of said left-handed covering;
at least partially-detaching from a rear surface of said right-handed covering, a right hand opening cover flap situated over a right operator hand opening on said rear surface of said right-handed covering; and
placing an operator's left and right hands through said left and right hand openings, respectively.

13. The method of claim 12, further comprising warming the operator's hands when those hands are placed through said operator hand openings, using at least one inside hand-warming layer of each of said left and right handlebar covers.

14. The method of claim 12, further comprising at least partially detaching said flaps from said coverings using a hook-and-loop system such as Velcro®.

15. The method of claim 12, further comprising at least partially detaching said flaps from said coverings using a zipper.

16. The method of claim 14, further comprising protecting said hook-and-loop system from debris using a zipper.

17. The method of claim 11, further comprising mutually attaching said left covering and said right covering to one another by mating to one another, a left-covering attachment of said left covering and a complementary right-covering attachment of said right covering.

18. The method of claim 11, further comprising:
tightening said left covering about the left handlebar using a left drawstring and lock system or equivalent running about a circumference of said left handlebar opening of said left covering; and
tightening said right covering about the right handlebar using a right drawstring and lock system or equivalent running about a circumference of said right handlebar opening of said right covering.

19. The method of claim 11, further comprising placing at least one commercial mark upon at least one of said coverings.

20. The method of claim 11 further comprising:
mutually attaching said left covering and said right covering to one another by mating to one another, a left-covering attachment of said left covering and a complementary right-covering attachment of said right covering;
tightening said left covering about the left handlebar using a left drawstring and lock system or equivalent running about a circumference of said left handlebar opening of said left covering;
tightening said right covering about the right handlebar using a right drawstring and lock system or equivalent running about a circumference of said right handlebar opening of said right covering;
at least partially-detaching from a rear surface of said left-handed covering, a left hand opening cover flap situated over a left operator hand opening on said rear surface of said left-handed covering;
at least partially-detaching from a rear surface of said right-handed covering, a right hand opening cover flap situated over a right operator hand opening on said rear surface of said right-handed covering;
placing an operator's left and right hands through said left and right hand openings, respectively; and
warming the operator's hands when those hands are placed through said operator hand openings, using at least one inside hand-warming layer of each of said left and right handlebar covers.
